(19) United States
(12) Patent Application Publication
(10) Pub. No.: US 2025/0293319 A1
(43) Pub. Date: Sep. 18, 2025

(54) POLYMER-SUPPORTED AND LITHIOPHILIC MATERIAL IMPREGNATED CARBON FIBER PROTECTION FOR LI-METAL STABILITY

(71) Applicant: Drexel University, Philadelphia, PA (US)

(72) Inventors: Krishna Kumar Sarode, Nizamabad, Telangana (IN); Vibha Kalra, Ithaca, NY (US)

(73) Assignee: Drexel University, Philadelphia, PA (US)

(21) Appl. No.: 18/859,703

(22) PCT Filed: Apr. 25, 2023
(86) PCT No.: PCT/US2023/066153

§ 371 Date: Oct. 24, 2024

Related U.S. Application Data
(60) Provisional application No. 63/363,502, filed on Apr. 25, 2022.

(51) Int. Cl. H01M 10/42; H01M 4/02; H01M 4/04; H01M 4/134; H01M 4/1395; H01M 4/62; H01M 10/052; H01M 10/0567; H01M 10/0569

(52) U.S. Cl. CPC H01M 10/4235; H01M 4/0402; H01M 4/0435; H01M 4/134; H01M 4/1395; H01M 4/62; H01M 10/052; H01M 10/0567; H01M 10/0569; H01M 2004/027; H01M 2004/028; H01M 2300/0037

(57) ABSTRACT

Methods of making a protected lithium metal anode including steps of: a) applying a polymer solution to a three-dimensional substrate to form a coated three dimensional substrate, b) applying the coated three dimensional substrate to a lithium metal surface to form a coated lithium metal surface, and applying pressure to the coated lithium metal surface to form the protected lithium metal anode. An anode formed by the method and cells and batteries employing the anode.

### CROSS REFERENCE TO RELATED APPLICATIONS

The application claims the benefit of U.S. Provisional Application No. 63/363,502, filed on Apr. 25, 2022, the entire disclosure of which is hereby incorporated by reference as if set forth fully herein.

### BACKGROUND OF THE INVENTION

Due to the numerous scientific and technical challenges of electrochemical energy storage systems, new kinds of batteries are being explored to improve performance and stability. For example. Li-metal anodes and nitrogen containing conductive polymer-sulfur composite cathodes are being improved. Furthermore, there are continuous changes in requirements for safe, stable, and high energy batteries for use in high energy applications and to reduce greenhouse gas emissions. For example, present Li-ion batteries have an energy density ranging from 220 W-h/kg to 250 W-h/kg, based on the weight of the battery, that do not adequately satisfy the demand for high energy applications, such as powering electric vehicles and for grid energy storage. Moreover, current Li-ion batteries use toxic materials and materials that are in short supply, which corresponds to increased costs and negative impacts on the environment. As such, there is a need for batteries with improved energy densities of at least 500 W-h/kg, which should be possible by replacing low-capacity graphite, e.g., 372 mAh/g, with lightweight, high-capacity Li-metal. e.g., 3860 mAh/g.

Li-metal batteries have been reassessed by many researchers since graphite-based Li-ion batteries cannot meet the growing demand of high energy density due to the low specific capacity of graphite. Lightweight, high-capacity Li-metal would be the obvious direction for commercialization of Li-metal batteries², however, it is known that many types of lithium metal batteries show poor cycle life due to dendrite growth and dead lithium formation, thus hindering their commercialization. Many strategies have been implemented to regulate the Li-ion flux, a few of which are Li—M alloys, where M=B, Al, Sn, C, Si etc.³, and lithium interface modification using an artificial solid electrolyte interface (SEI) and organic electrolyte additives⁴.

Applying carbon-based materials for Li-metal stabilization is a convenient and effective strategy. Different carbon-based materials like carbon nanotubes (CNT)⁵, graphite⁶, graphene⁷and graphdiyne⁸ may be employed for Li-metal stabilization. These carbon structures are preferred because of their advantageous properties, for example, high thermal and electrical conductivity, good chemical stability, and mechanical strength. The carbon may be used in various forms like 3D structures⁹ that act as a host for the Li-metal and reduce the local current density, thus allowing for uniform lithium deposition and stripping. However, the lack of nucleation sites in the 3D structures make them less effective in uniform lithium reflux at high current densities or high active material loadings. As such, there is a need to improve these carbon structures to minimize dendrite growth and dead lithium formation.

### SUMMARY

The present invention may be described by the following sentences:

1. In a first aspect, the present invention relates to a method of making a protected lithium metal anode comprising steps of:
a) applying a polymer solution to a three-dimensional substrate to form a coated three dimensional substrate,
b) applying the coated three dimensional substrate to a lithium metal surface to form a coated lithium metal surface, and
c) applying pressure to the coated lithium metal surface to form the protected lithium metal anode.

2. The method of sentence 1, wherein the three-dimensional substrate may comprise one or more lithiophilic components dispersed therein.

3. The method of sentence 2, wherein one or more lithiophilic components may be present in an amount of from about 1 wt. % to about 30 wt. %, or from about 3 wt. % to about 25 wt. %, or from about 6 wt. % to about 20 wt. %, based on the total weight of the protected lithium metal anode.

4. The method of any one of sentences 2-3, wherein the one or more lithiophilic components may be selected from the group consisting of silica, silicon-containing nanoparticles, zinc oxide, cupric oxide, three-dimensional carbon nanotubes, metal oxides, metals, and graphene.

5. The method of any one of sentences 2-4, wherein the three-dimensional substrate may comprise one or more lithiophilic components prepared by:
immersing the three-dimensional substrate in the one or more lithiophilic components to form a mixture, and
mixing the mixture to form a three-dimensional substrate having the one or more lithiophilic components dispersed therein.

6. The method of any one of sentences 1-5, wherein the polymer solution of step a) may be prepared by:
dissolving a polymer in an organic solvent at a weight ratio of polymer to solvent of 1:0.5 to less than 1:9, or a weight ratio of polymer to solvent of about 1:1 to form the polymer solution.

7. The method of any one of sentences 1-6, wherein the step of applying pressure mat cause pre-lithiation of the three dimensional substrate and, optionally, one or more of said lithiophilic components of the three dimensional substrate, if present.

8. The method of any one of sentences 1-7, wherein the three dimensional substrate may be selected from the group consisting of a solid carbon ball, a hollow carbon ball, a porous carbon, single-layer of carbon nanotubes, multiple layers of carbon nanotubes, carbon fibers, doped carbon fibers, and graphene cages.

9. The method of any one of sentences 1-8, wherein the polymer solution may be present in an amount of from about 0.1 wt. % to about 8 wt. %, or from about 1 wt. % to about 6.5 wt. %, or from about 2 wt. % to about 5 wt. %, based on the total weight of the protected lithium metal anode.

10. The method of any one of sentences 1-9, wherein the step b) may be carried out using drop casting.

11. The method of any one of sentences 1-10, wherein the step of applying pressure may be carried out by roll pressing at about 0.1 rpm to about 0.5 rpm, or at about 0.328 rpm.

12. The method of any one of sentences 1-11, wherein the polymer may be a high tensile strength polymer, and, optionally, the polymer may be selected from the group consisting of polyvinylidene fluoride, and polyvinylidene fluoride-hexafluoropropylene, nylon, polyphenylene sulfide (PPS), or the polymer is polyvinylidene fluoride-hexafluoropropylene.

13. The method of any one of sentences 1-12, wherein the polymer solution may be prepared using a solvent and the solvent may be an organic solvent, or the solvent may be selected from the group consisting of dimethyl formamide and acetone.

14. The method of any one of sentences 1-13, wherein the three dimensional substrate may comprise carbon fibers having an average diameter of from about 250 nm to about 2 μm, or from about 75 nm to about 3 μm, or from about 50 nm to about 10 μm.

15. In a second aspect, the present invention relates to a protected lithium metal anode prepared by the method of any one of sentences 1-14.

16. In a third aspect, the present invention relates to a cell comprising the protected lithium metal anode of sentence 15, an electrolyte, and a cathode.

17. The cell of sentence 16, wherein the cathode may comprise one or more of sulfur, graphite, sulfurized carbon, LiFePO₄ (LFP), LiMn₂O₄ (LMO), lithium nickel manganese spinel (LNMO), lithium cobalt oxide, V₂O₅, lithium nickel cobalt manganese oxide (NMC), and electrically conductive polymers.

18. The cell of sentence 16, wherein the cathode may be prepared by:
a) mixing a conductive polymer, a nitrogen-containing polymer, or a combination of a conductive polymer and a nitrogen-containing polymer with sulfur in the presence of a solvent to form a mixture, wherein a weight ratio of the conductive polymer and/or nitrogen containing polymer to the sulfur is from about 1:2 to about 1:8; and
b) heating the mixture to a temperature of from about 250° C. to about 400° C. under a pressure of from about 0.05 bar to about 2.0 bar to form the cathode.

19. The cell of any one of sentences 16-18, wherein the electrolyte may be a carbonate electrolyte, and, optionally, the carbonate electrolyte may be selected from the group consisting of ethylene carbonate, dimethylcarbonate, methylethyl carbonate, fluoro-ethylene carbonate, diethylcarbonate, propylene carbonate, vinylene carbonate, allyl ethyl carbonate, and mixtures thereof.

20. The cell of any one of sentences 16-19, wherein the electrolyte may comprise a stabilizing agent, and optionally, the stabilizing agent is 1,1,2,2-tetrafluoroethyl-2,2,3,3-tetrafluoropropyl ether.

21. The cell of sentence 20, wherein the stabilizing agent may be present in an amount of 2 vol. % to about 5 vol. %, based on the total volume of the electrolyte.

22. In a fourth aspect, the present invention relates to a battery comprising one or more of the cells according to any one of sentences 16-21.

23. The battery of sentence 22, may have an energy density of about 350 W-h/kg to about 700 W-h/kg, or about 350 W-h/kg to about 670 W-h/kg, or about 350 W-h/kg to about 600 W-h/kg, or about 350 W-h/kg to about 500 W-h/kg, based on the weight of the battery.

24. In a fifth aspect, the present invention relates to a protected lithium metal anode comprising:
lithium metal;
an elastic high tensile polymer layer, and
a pre-lithiated three dimensional substrate optionally impregnated with one or more lithiophilic components.

25. The protected lithium metal anode of sentence 24, wherein the polymer of the polymer layer may be selected from the group consisting of polyvinylidene fluoride, and polyvinylidene fluoride-hexafluoropropylene, nylon, polyphenylene sulfide (PPS), or the polymer is polyvinylidene fluoride-hexafluoropropylene.

### BRIEF DESCRIPTION OF THE DRAWINGS

FIG. 1 shows scanning electron microscope (SEM) images of a lithium metal roll pressed with PVDF-HFP coated carbon fiber GDL in the top row. Images a) and b) show a top view, and image c) shows a cross sectional view. The bottom row of FIG. 1 shows SEM images of a lithium metal roll pressed with PVDF-HFP coated Si impregnated Silicon GDL. Images d) and e) show a top view, and image f) shows a cross sectional view.

FIG. 2A shows X-ray photoelectron spectroscopy (XPS) of Li 1s spectra of lithium metal protected with PVDF-HFP coated GDL.

FIG. 2B shows XPS of Li 1s spectra of lithium metal protected with PVDF-HFP coated GDL-Si.

FIG. 2C shows XPS of Si 2P spectra of PVDF-HFP coated GDL.

FIG. 2D shows XPS Si and SiS2 spectra of PVDF-HFP coated GDL-Si

FIG. 3A shows a comparison of cycle life of a pouch cell comprising lithium metal rolled pressed with silicon impregnated with GDL and pristine GDL roll pressed lithium.

FIG. 3B shows a comparison of voltage profiles of a pouch cell comprising lithium metal roll pressed with silicon impregnated with GDL and pristine GDL roll pressed lithium in the fourth cycle.

FIG. 3C shows a comparison of voltage profiles of a pouch cell comprising lithium metal roll pressed with silicon impregnated with GDL and pristine GDL roll pressed lithium in the 50^{th} cycle.

FIG. 3D shows a comparison of voltage profiles of a pouch cell comprising lithium metal roll pressed with silicon impregnated with GDL and pristine GDL roll pressed lithium in the 100^{th} cycle.

FIG. 4 shows the cycle life of pouch cells with pristine lithium and a sulfurized polyacrylonitrile (SPAN) cathode having loadings of from 2-5 mg/cm². All of the pouch cells were cycled at C/5 and showed poor electrochemical performance in terms of capacity retention and cycle life. Rapid capacity fade was due to the lack of a stable lithium interface which permits dead lithium to form in the SEI in each cycle and result in consumption of the electrolyte leading to electrolyte runaway.

FIG. 5A shows a comparison of electrochemical impedance spectroscopy (EIS) of coin cells comprising lithium protected with a gas diffusion layer of poly(vinylidenefluoride) (GDL-PVDF) and GDL-SI-PVDF as anode and SPAN as cathode at open circuit voltage.

FIG. 5B shows a comparison of electrochemical impedance spectroscopy (EIS) of coin cells comprising lithium protected with GDL-PVDF and GDL-SI-PVDF as anode and SPAN as cathode after 20 cycles.

FIG. 5C shows a comparison of electrochemical impedance spectroscopy (EIS) of coin cells comprising lithium protected with GDL-PVDF and GDL-SI-PVDF as anode and SPAN as cathode after 40 cycles.

FIG. 5D shows a comparison of electrochemical impedance spectroscopy (EIS) of coin cells comprising lithium protected with GDL-PVDF and GDL-SI-PVDF as anode and SPAN as cathode after 70 cycles.

FIG. 5E shows a comparison of electrochemical impedance spectroscopy (EIS) of coin cells comprising lithium protected with GDL-PVDF and GDL-SI-PVDF as anode and SPAN as cathode after 80 cycles.

FIG. 6 shows in the left image, lithium with a 25.5 cm² area coated by a carbon fiber mat and in the right image, carbon fiber mat impregnated with lithiophilic material. Both were prepared using roll pressing.

FIG. 7 shows in the top row, SEM images of a lithium metal protected with poly(vinylidenefluoride-co-hexafluoropropylene) PVDF-HFP coated GDL after 30 cycles and in the bottom row, lithium metal protected with PVDF-HFP coated GDL-Si.

### DETAILED DESCRIPTION

The present invention relates to methods of preparing stable lithium metal interfaces by protecting the lithium surface with a 3D substrate, for example, a carbon fiber gas diffusion layer (GDL) mat, optionally impregnated with lithiophilic sites. A high tensile strength polymer, such as polyvinylidene fluoride-hexafluoro propylene (PVDF-HFP), is employed as a coating on the carbon fiber to improve its mechanical strength in order to prevent pulverization of carbon fibers during roll pressing. Stable cycling of pouch cells with an areal capacity of 2-3 mAh/cm² may be attained for 200 cycles when the pouch cell is protected with the carbon fiber mat.

Lithium metal stability may be further improved by introducing a lithiophilic material, such as silicon in the carbon fiber GDL. Pouch cells using lithium protected with silicon impregnated carbon fiber GDL demonstrated an areal capacity of 3-4 mAh/cm² for 200 cycles. This improvement is attributed to the presence of the lithiophilic material and carbon fiber GDL mat that creates a directed path for lithium thus stabilizing the lithium interface during high current density operation.

Lithiophilic sites improve the lithium affinity thus promoting directed lithium deposition. The carbon fibers of the GDL may have a diameter ranging from about 250 nm to about 4 μm, or from about 500 nm to 2 μm. The carbon fiber GDL mat is used as a 3D host for lithium. The carbon fibers preferably have a hard carbon nature. The lithiophilic materials may be selected from Si, ZnO, Sn, CuO, 3D carbon nanotubes (CNT), graphene¹⁰, etc. which are dispersed/impregnated in between the fibers of the carbon fiber GDL mat. For uniform dispersion, a colloidal solution of lithiophilic material is made by mixing it with non-aqueous solvents like acetone, dimethyl formamide, etc. using a speed mixer. The carbon fiber GDL mat is then immersed in this solution and subjected to speed mixing whereby lithiophilic particles are impregnated between the carbon fibers of the mat. Finally, the carbon fiber GDL mat is coated with a solution of a high tensile strength polymer like PVDF-HFP, dissolved in a solvent, such as acetone. In addition to imparting integrity to the carbon fibers during roll pressing, PVD-HFP also immobilizes the lithiophilic particles present between the carbon fibers of the GDL mat and supports the volume change during cycling. The combined effect of the 3D carbon structure with the lithium affinity sites provided by the lithiophilic material, and the high tensile strength polymer improves the lithium interface stability, lowers the local current density and regulates the lithium flux.

Additionally, fluorinated electrolytes may be used for forming the stable SEI during initial cycling. The interface of the carbon fiber GDL mat may be further stabilized using a stabilizing agent, such as 1,1,2,2-tetrafluoroethyl-2,2,3,3-tetrafluoropropyl ether (TTE). The TTE may be present in a range of about 2 vol % to about 5 vol %, based on the total volume of the electrolyte.

The present invention relates to roll pressing of a carbon fiber GDL mat impregnated with a lithiophilic material and coated with a high tensile strength polymer on the lithium surface which facilitates the pre-lithiation of the carbon fiber GDL mat. Specifically, roll pressing develops the channels for lithium transport that tune the lithium plating and stripping. Moreover, the 3D configuration of the carbon fiber mat reduces the local current density and controls the lithium stripping and plating, which hinders dendrite formation. The method of the present invention is effective and cost efficient for stabilizing Li-metal compared to other known methods.

In addition, the carbon fiber mat acts as a host/skeleton for the lithium and improves the interconnectivity of any improperly plated lithium with the current collector thus reducing the formation of dead lithium. Lithiophilic material impregnated in the carbon fiber mat further improves the uniformity of lithium plating and stripping since it induces the directed deposition and stripping of lithium. Coating with high tensile strength polymers improve the mechanical strength of the carbon fiber mat and prevents pulverization of the carbon fibers during roll pressing. Further, the elastic modulus of the polymer immobilizes and supports the volume change of the lithiophilic materials, such as silicon, ZnO, CuO, 3D CNT, graphene, etc. during cycling, thus improving the cycle life. TTE may be used as an additive to further stabilize the SEI especially on the hard carbon fiber mat.

To prepare the protected anode, the lithiophilic material is impregnated into the carbon fiber mat by a solution-based method. After drying, the carbon fiber mat impregnated with lithiophilic material is coated with a high tensile strength polymer, such as PVDF-HFP, nylon, polyphenylene sulfide (PPS), etc. This combination may be called a carbon fiber mat composite. Finally, the carbon fiber mat composite is placed on the Li-metal surface and roll pressed.

The Li-metal protected with the carbon fiber mat composite may have a thickness of from about 50 μm to about 700 μm, or from about 100 μm to about 600 μm, or about 100 μm, or about 250 μm, or about 500 μm, or about 600 μm. The carbon fiber mat used to protect the Li-metal may have fibers with diameters ranging from 500 nm to 2 μm. The carbon fiber mat may have fibers having an average diameter of from about 50 nm to about 10 μm, or from about 75 nm to about 3 μm, or from about 250 nm to about 2 μm.

The conformality of the carbon fiber mat coating on the Li-metal surface may be tuned by changing the distance between the rollers of the roll press.

The polymeric solution may be prepared with a variety of different weight percentages by mixing the polymer into non-aqueous solvents like acetone, dimethyl formamide, etc, dimethyl sulfoxide, tetrahydrofuran, ethyl acetate, N-methyl-2-pyrrolidone, chloroform, hexane, toluene, cyclohexanone, preferably, acetone or dimethyl formamide.

Anodes prepared by the method of the present invention may be used with any suitable cathode such as those known in the art for use with lithium-containing anodes.

### EXAMPLES

Materials for Sulfurized polyacrylonitrile (SPAN) synthesis—Polyacrylonitrile (M_{w}=150,000 g mol⁻¹, purchased from Sigma Aldrich) and sulfur (99.5%, sublimed, catalog no. AC201250025), Ethanol (Sigma Aldrich, 99%).

Materials for SPAN electrode making—Carbon black-Super P [Alfa aesar], sodium carboxy methyl cellulose [Alfa aesar], and styrene butadiene rubber (MTI corporation).

Materials for stabilizing the Li-metal—Polyvinylidene fluoride—hexafluoro propylene (Aldrich chemistry), dimethyl formamide (Fisher chemicals), acetone, silicon nanoparticles (100 nm), and GDL fibers (Gas diffusion layer—carbon fiber layer)(3-5 μm diameter).

Materials for electrochemistry—1M lithium hexafluoro phosphate in ethylene carbonate and diethyl carbonate [1:1] [LiPF6 in EC:DEC-—Aldrich], fluoro-ethylene carbonate [FEC-Alfa aesar], and 1,1,2,2 tetrafluoro ethyl, 2,2,3,3 tetrafluoro propyl ether (TTE) (TCI).

### SPAN Synthesis

SPAN was synthesized by mixing Polyacrylonitrile (M_{w}=150,000 g mol⁻¹, purchased from Sigma Aldrich) and Sulfur (99.5%, sublimed, catalog no. AC201250025) in 1·4 wt. % and wet ball milled for 12 hours at 400 rpm using ethanol as solvent [Sigma Aldrich, 99%]. The mixture was dried at 50° C. in a vacuum oven for 6 hours and finally heat treated in a Tubular furnace [Nabertherm] at 350° C. for 4 hours under nitrogen flow to form SPAN [Sulfurized carbon]. For open synthesis, the polyacrylonitrile (PAN)/S mixture was kept in an open ceramic boat, while for closed synthesis the PAN/S mixture was placed in the alumina ceramic boat closed with the alumina plate followed by wrapping with aluminum foil. For doped SPAN, 2 wt. % of Cobalt chloride (Acros oganics) was added to the PAN/S mixture followed by wet ball milling. The cobalt doped samples were also synthesized in the closed and open system.

### Lithium Treatment—Preparation of a 4 wt/vol % PVDF-HFP—Acetone Solution and Protection of Li-metal by PVDF-HFP Coated GDL

400 mg PVDF-HFP was dissolved in 10 ml of the acetone and stirred for 12 hours to make a 4 wt/vol % homogenous solution. The PVDF-HFP solution was drop casted onto the GDL and dried leaving the polymer coating on the GDL fibers. The obtained PVDF-HFP coated GDL was placed on the Lithium metal surface followed by roll pressing at 0.328 rpm till the desired thickness was achieved. After roll pressing, the fibers were impregnated with the lithium resulting in pre-lithiation of the fibers and Silicon.

### Lithium Treatment—Preparation of a 4 wt/vol % PVDF-HFP—Acetone Solution and Protection of Li-metal by PVDF-HFP Coated GDL-Si—

400 mg PVDF-HFP was dissolved in 10 ml of the acetone and stirred for 12 hours to make a 4 wt/vol % homogenous solution. For making GDL-Si, 10 wt/vol % of silicon in acetone was made and GDL fibers were immersed in the silicon-acetone solution and rotated at 2000 rpm for 2 minutes during which silicon nano particles were distributed uniformly throughout the GDL fibers. The process of rotation was repeated until a desired weight of silicon was dispersed onto and in between the GDL fibers after which they were dried and drop casted with the PVDF-HFP solution which dried in 2 minutes leaving the polymeric coating onto the GDL fibers which also immobilized the silicon nano particles. The as obtained PVDF-HFP coated GDL-Si was placed on the Lithium metal surface followed by roll pressing at 0.328 rpm until the desired thickness was achieved. After roll pressing, the fibers were impregnated with lithium resulting in pre-lithiation of the fibers and Silicon.

### Material characterizations—SEM/EDS, FTIR, XPS, Elemental analysis, DLS

The morphological analysis of the materials was conducted using a Scanning electron Microscope (SEM) (Zeiss Supra 50VP, Germany) with an in-lens detector, and a 30-mm aperture was used to examine the morphology and to obtain micrographs of the samples. To analyze the surface elemental composition. Energy Dispersive X-ray Spectroscopy (EDS) (Oxford Instruments) in secondary electron-detection mode was used. The surface of the composites was analyzed with X-ray photoelectron spectroscopy (XPS). To collect the XPS spectra, Al-Ka X-rays, with spot sizes of 200 mm and a pass energy of 23.5 eV were used to irradiate the sample surface. The Al-Ka X-rays use an aluminum element as its source and the X-rays are produced due to the transition of electrons between the core energy levels, i.e. the fall of electrons from the L-shell to the K-shell. A step size of 0.05 eV was used to gather the high-resolution spectra. CasaXPS (version 23.19PR1.0) software was used for spectra analyses. The XPS spectra were calibrated by setting the valence edge to zero, which was calculated by fitting the valence edge with a step-down function and setting the intersection to 0 eV. The background was determined using the Shirley algorithm, which is a built-in function in the CasaXPS software. The infrared spectra of the samples were collected using a Fourier transform infrared (FTIR) spectrometer (Nicolet iS50, Thermo-Fisher Scientific) using an extended range diamond ATR accessory. A deuterated triglycine sulfate (DTGS) with a resolution of 64 scans per spectrum at 8 cm⁻¹ was used and all the spectra were further corrected with background, baseline correction and advanced ATR correction in the Thermo Scientific Omnic software package.

### Electrode Making

Initially, 80 wt. % of SPAN and 10 wt. % carbon black super P were mixed in a Flacktek speed mixer for 5 minutes. The homogenous 4 volume percent sodium carboxymethylcellulose-styrene-butadiene ruber (NaCMC-SBR) binder was made in another vial using water as the solvent in the Flacktek speed mixer. Then the SPAN-Carbon black mixture was added to the binder solution in an amount to make up 10 wt. % of the complete electrode slurry and speed mixed for 1 hour at 2500 rpm with 5 minutes gap for each cycle. The resultant electrode slurry was coated onto the carbon coated aluminum foil using an applicator with a thickness of 250 micrometers followed by drying in oven at 50° C.

### Coin-Cell Fabrication

The dried electrodes were cut using a hole punch (f=0.5 inch [12.7 mm]) to form disk-sized electrodes. The electrodes were then weighed and transferred to an argon-filled glove box (MBraun LABstar, O₂<1 ppm and H₂O<1 ppm). The CR2032 (MTI and Xiamen TMAX Battery Equipments, China) coin-type Li—S cells were assembled using SPAN (f=12 mm), lithium disk anodes (Xiamen TMAX Battery Equipment's; f=15.6 mm, 450 mm thick), a tri-layer separator (Celgard 2325; f=19 mm), one stainless-steel spring, and two spacers, along with an electrolyte. The electrolyte with 1M LiPF₆ in ethylene carbonate: diethyl carbonate (EC:DEC) 1:1 volume ratio was purchased from Aldrich chemistry, with H₂O<6 ppm and O₂<1 ppm. The assembled coin cells were rested at their open-circuit potential for 12 hours to equilibrate them before performing electrochemical experiments at room temperature. Cyclic voltammetry was performed at various scan rates (0.5 mV/s) between voltages of 1 V and 3 V with respect to Li/Li+ with a potentiostat (Biologic VMP3). Prolonged cyclic stability tests were carried out with a Neware BTS 4000 battery cycler at different C-rates (where 1C=650 mAhg⁻¹) between voltages 1.0 and 3.0 V.

### Pouch Cell Fabrication

Cathodes were punched with dimensions 57 mm×44 mm using a die cutter MSK-T-11 (MTI, USA). A 4-inch (101.6 mm) length lithium strip (750 um thick, Alfa Aesar) was rolled by placing in between aluminum-laminated film to get a 60 mm×50 mm Li sheet using an electric hot-rolling press (TMAX-JS) at 0.328 rpm inside the glove box (MBraun, LABstar Pro). Once the final dimensions of lithium were achieved (approximately 400 μm-500 μm thick-by adjusting the distance between the rollers of the roll press), it was re-rolled with a copper current collector (10 mm) to achieve good adhesion. Finally, the lithium-rolled copper sheet was punched with a 58-mm×45-mm die cutter (MST-T-11) inside the glove box. The cathode and anode were welded with aluminum and nickel tabs (3 mm), respectively. The tabs were welded with an 800-W ultrasonic metal welder, with a 40 KHz frequency; a delay time of 0.2 s, welding time of 0.15 and 0.45 s for Al|Al and Cu|Ni, respectively; and a cooling time of 0.2 s with 70% amplitude. The anode and cathode were placed between a Celgard 2325 separator, and the pouch was sealed with 3-in-1 heat pouch sealer inside the glove box with a 95 kPa vacuum, 4-s sealing time at 180 C and a 6-s degas time.

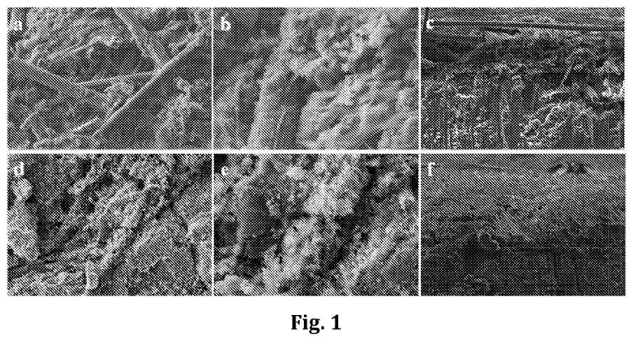

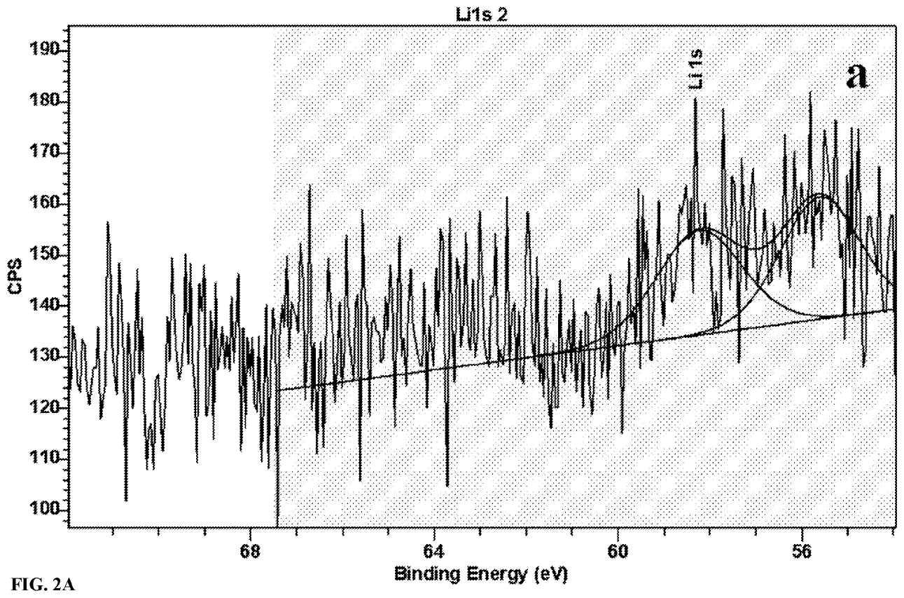

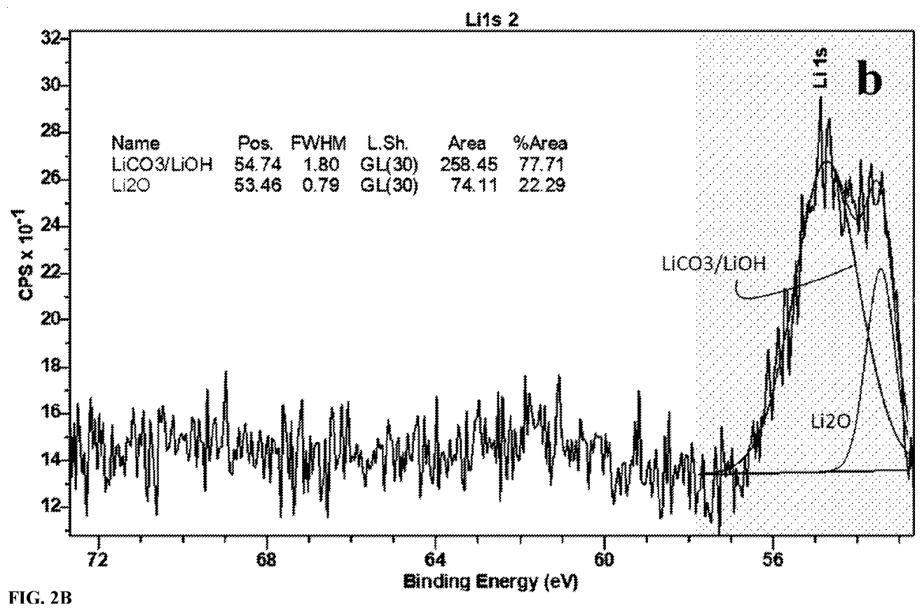

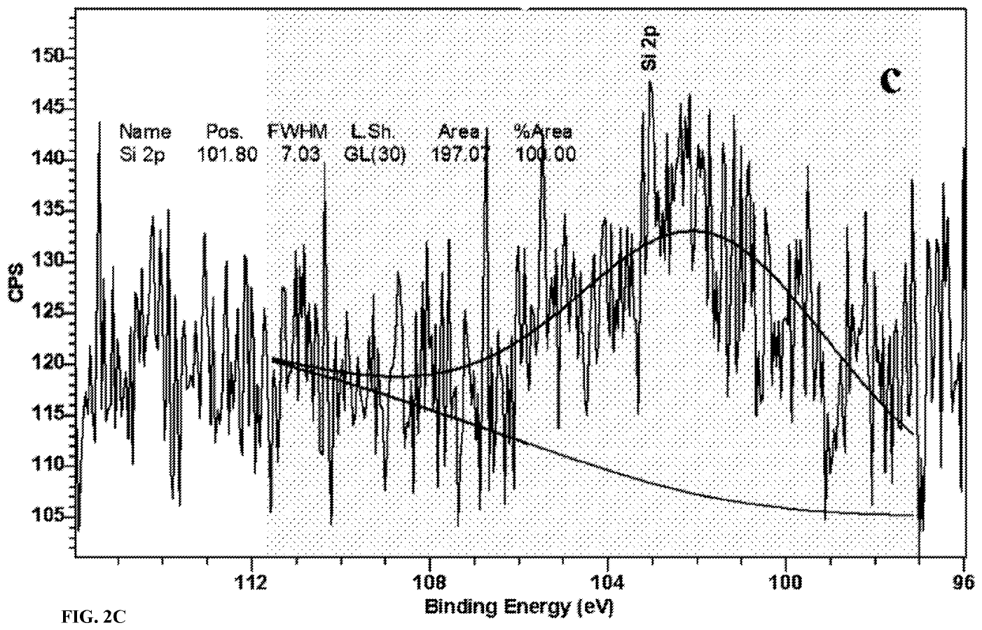

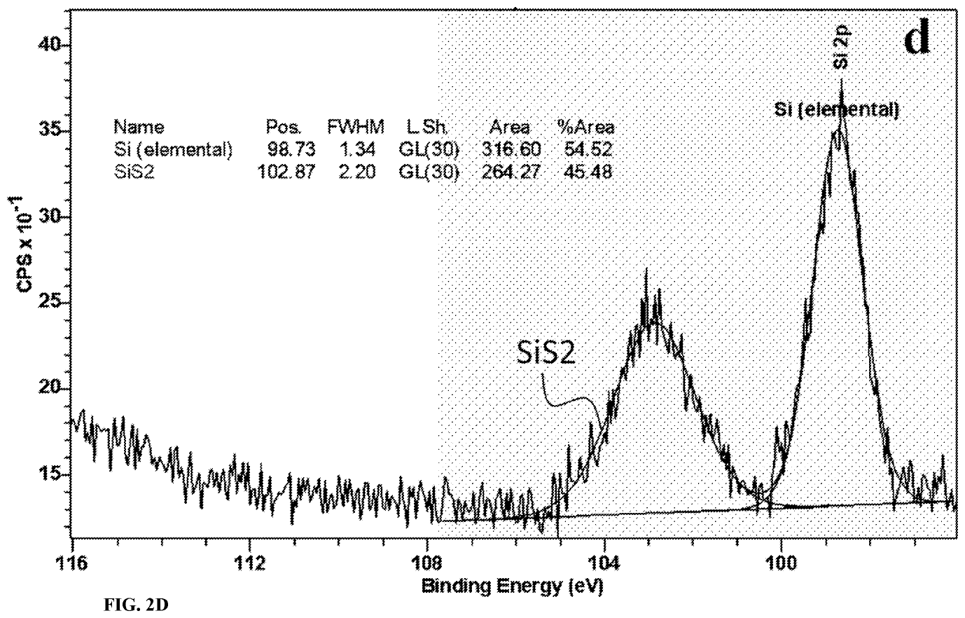

FIGS. 1A, 1B, and 1C show the SEM images of the GDL carbon fibers roll pressed on lithium. These roll-pressed carbon fibers were inserted into the bulk of the lithium to act as a skeleton, as evidenced in FIG. 1A. The inserted GDL fibers were pre-lithiated, thus creating channels for lithium plating and stripping [FIG. 1B]. The cross-sectional SEM image [FIG. 1C] shows that the thickness of the carbon fiber was about 10-15 μm. Silicon impregnated GDL fibers show complete filling with lithium due to uniform distribution of the silicon throughout the GDL fibers. FIGS. 1D and 1E show that the fibers were completely coated with lithium thus creating lithium affinity sites in addition to the pre-lithiated channels. The lithiophilic material improves utilization of the entire GDL fiber mat which is evidenced by the fibers no longer being exposed as shown in FIGS. 1D and 1E when compared to FIGS. 1A and 1B which show exposed GDL fibers roll pressed onto the lithium with silicon. FIG. 1F is a cross-sectional image of the silicon impregnated GDL roll pressed on the lithium showing a thickness of about 10 μm-15 μm.

XPS was conducted to distinguish the pre-lithiation of GDL with and without silicon combined with etching technology. Li 1s spectra of GDL protected lithium electrode after pre-lithiation of GDL showed a peak at ˜57.2 eV corresponding to Li₂O. A small peak at ˜55 eV corresponding to Li metal. Whereas the Li 1s spectra of the GDL-Si protected lithium electrode after pre-lithiation showed a prominent peak at ˜54.2 eV corresponding to LiₓSi and another peak at ˜55 eV corresponding to Li metal. This suggests the formation of Li—Si alloy after roll pressing of the PVDF-HFP coated GDL-Si onto the lithium metal. The silicon 2p spectra of GDL-Li does not show any characteristic peaks of silicon and GDL-Si—Li shows a peak at 98.5 eV corresponding to bulk silicon.¹¹

### Electrochemistry

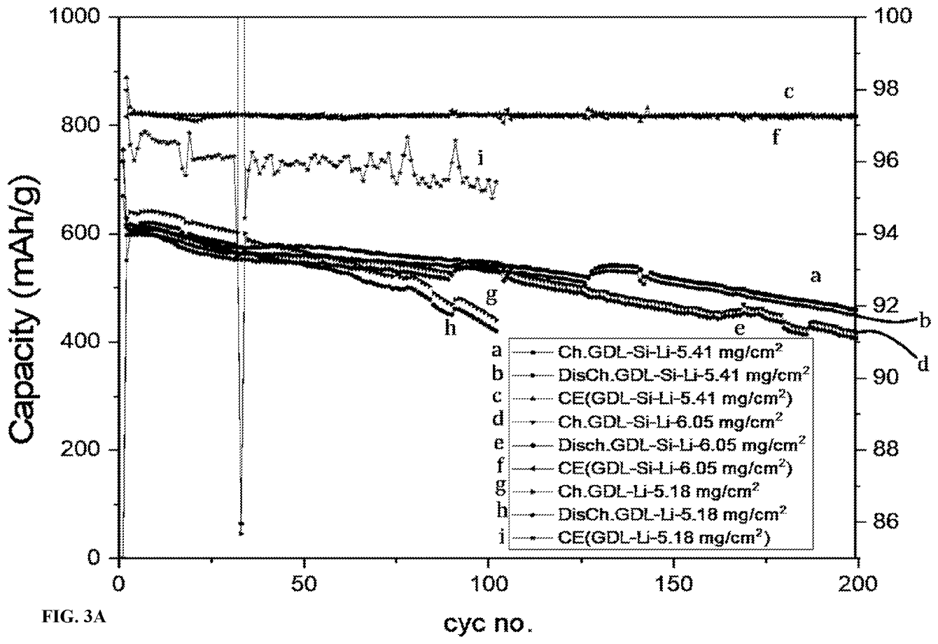

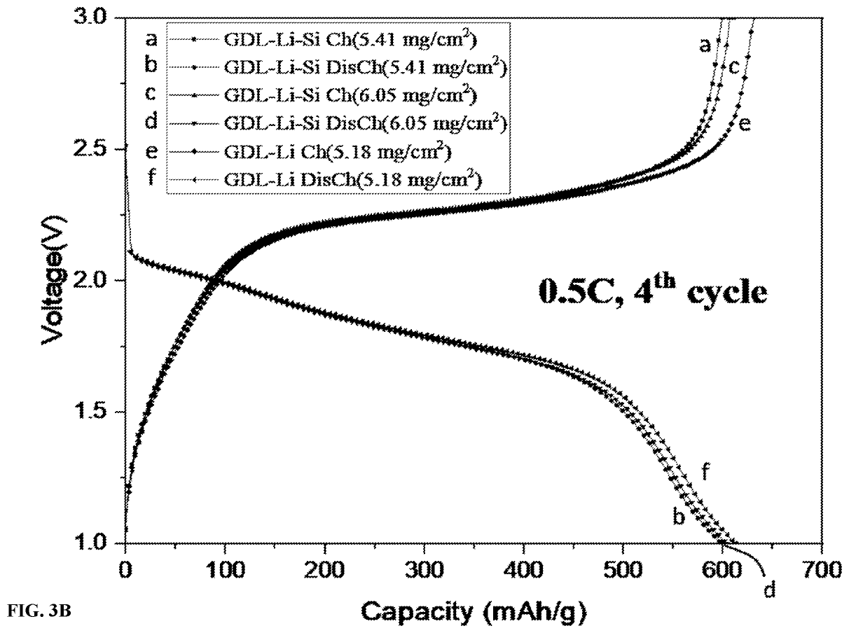

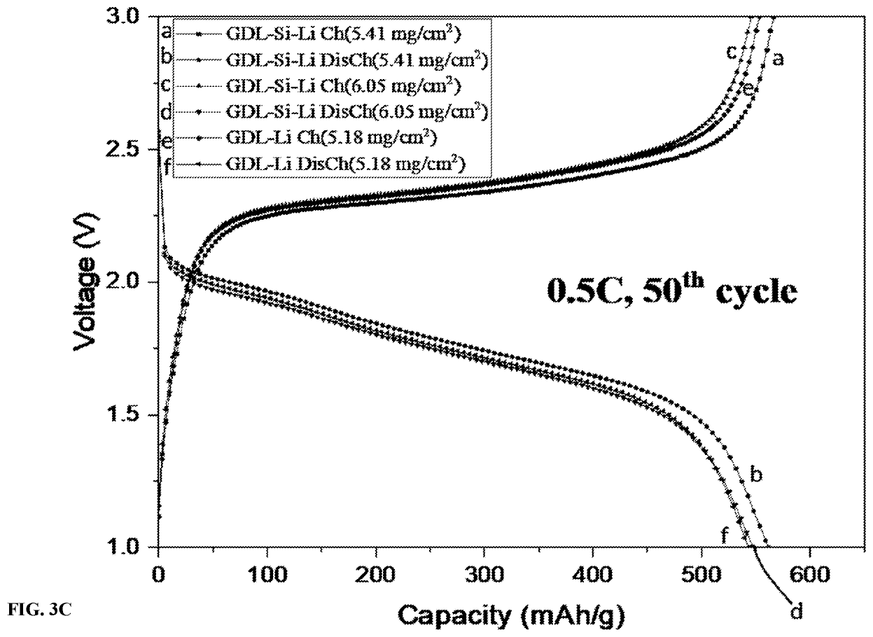

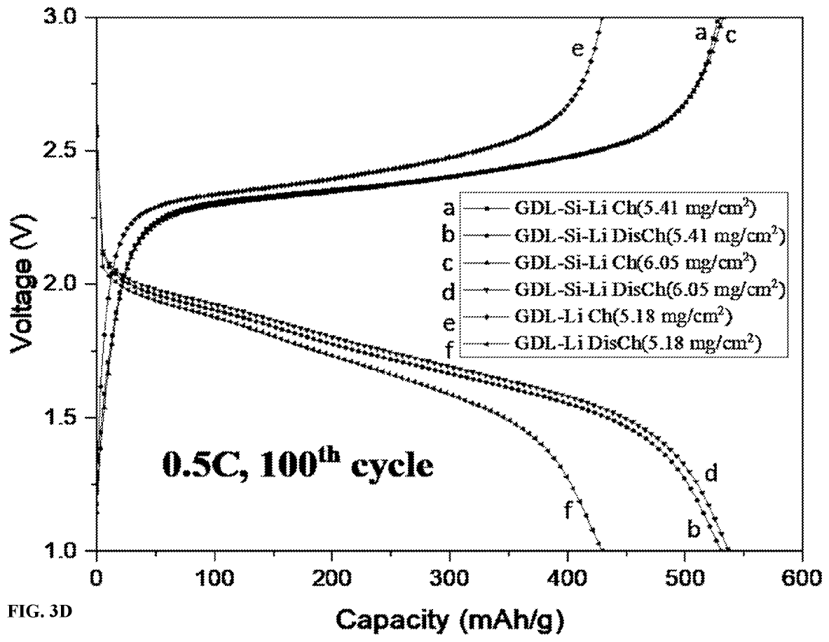

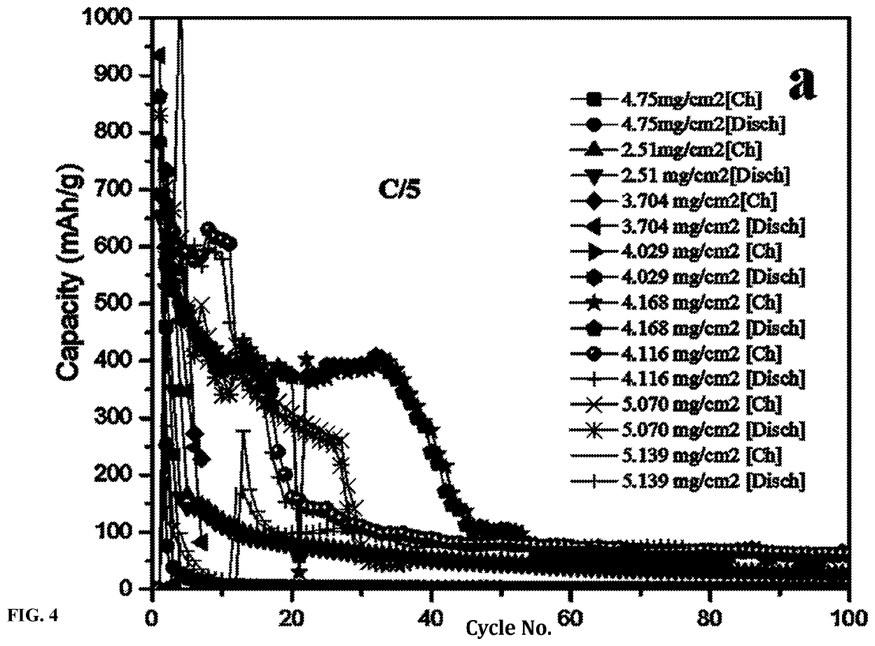

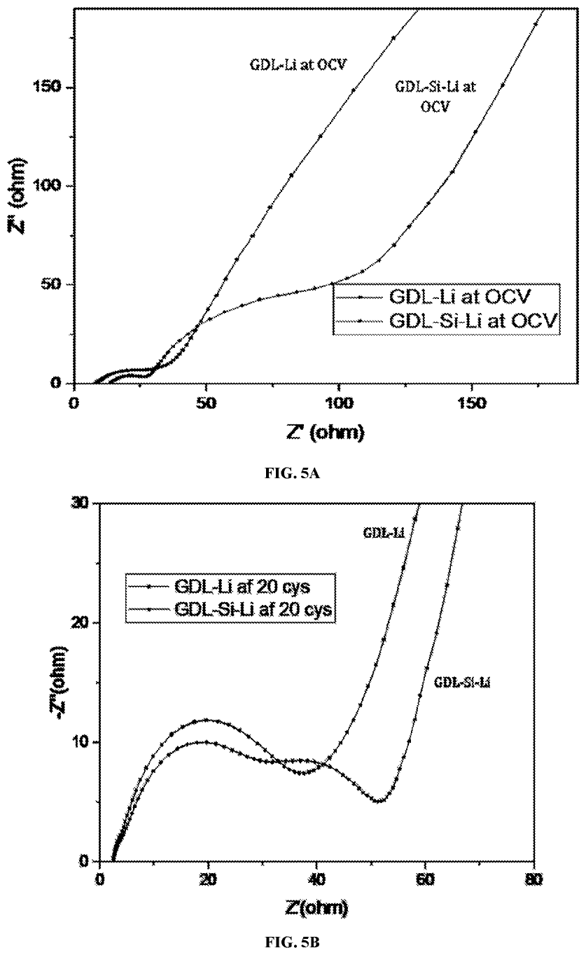

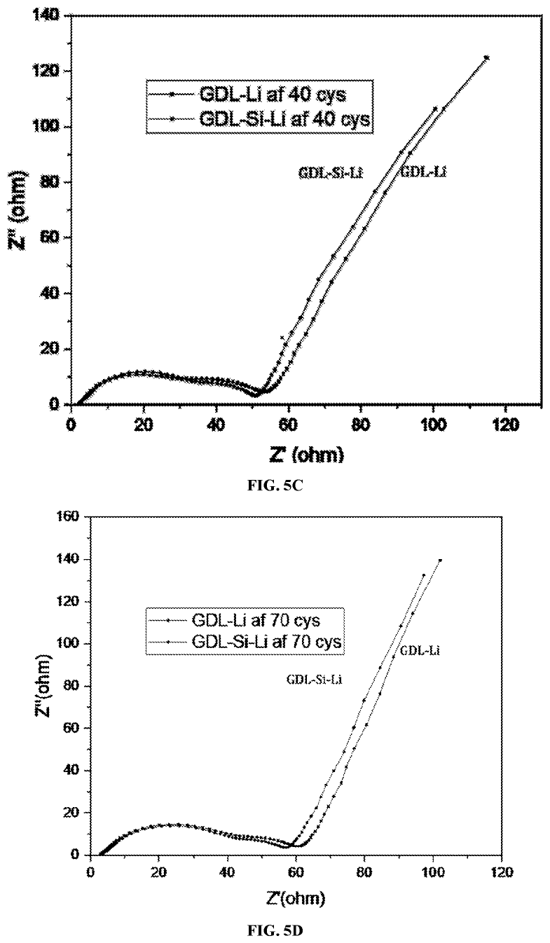

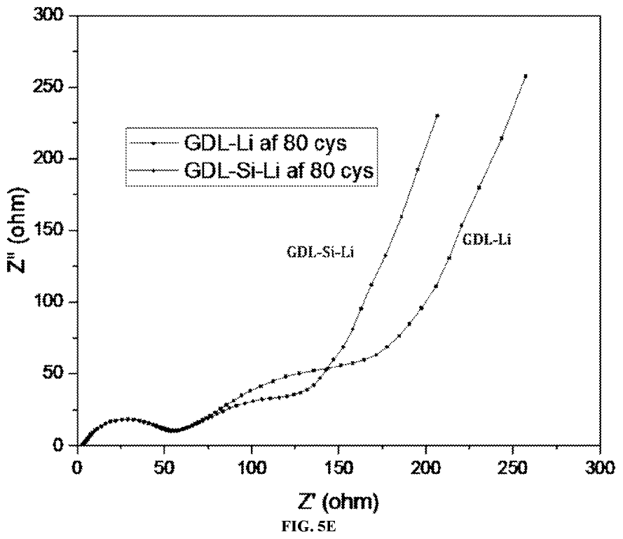

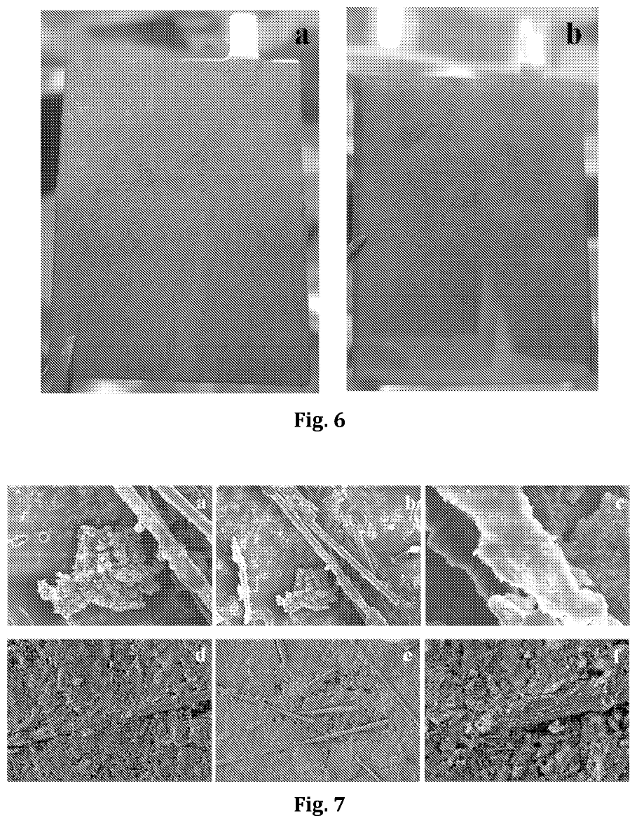

FIG. 3A is a comparison of the cycle life of pouch cells including lithium roll pressed with silicon impregnated with GDL and pristine GDL roll pressed with lithium. The pouch cell with silicon impregnated GDL shows a stable cycle life with good capacity retention with both the 5.41 mg/cm² and the 6.05 mg/cm² SPAN active material loadings, and a coulombic efficiency of nearly 97-98%. In contrast, the pouch cell with the pristine GDL roll pressed with lithium showed an initial high capacity of 630 mAh/g but also exhibited a rapid capacity fade with poor coulombic efficiency.

FIG. 3B shows a comparison of the voltage profiles of the pouch cells in the fourth cycle. The pouch cell with a cathode loading of 5.41 mg/cm² and lithium coated with a carbon fiber GDL mat and lithiophilic material showed a discharge capacity of 605 mAh/g[C/2] at the 4th cycle. 560 mAh/g[C/2] at the 50^{th} cycle and 540 mAh/g at the 100^{th} cycle. The pouch cell with a 6.05 mg/cm² cathode loading having lithium protected with silicon impregnated GDL fibers showed a discharge capacity of 603 mAh/g at the 4^{th} cycle, 550 mAh/g at the 50^{th} cycle and 535 mAh/g at the 100^{th} cycle.

In contrast, the pouch cell having a cathode loading of 5.18 mg/cm² and having the lithium coated with a pristine GDL fiber mat demonstrated a discharge capacity of 600 mAh/g at the 4^{th} cycle, 540 mAh/g at the 50^{th} cycle and 425 mAh/g at the 100^{th} cycle. Accordingly, there was a 7.5% loss of capacity in the case of the lithium protected with the GDL fiber mat bearing the lithiophilic material for both cathode loadings, but a 29% loss in capacity was seen in the pouch cell with lithium protected by the GDL fiber mat without the lithiophilic material at the 100^{th} cycle and complete capacity fade was seen after that. Further, there was low polarization and stable cycling with high capacity until 200 cycles in the pouch cell with the lithiophilic material.

These results suggest that there is an improvement in the stability of the roll pressed lithium metal interface coated with the GDL fiber mat and impregnated with lithiophilic material. Furthermore, pre-lithiation creates a pathway for the Li-ion movement during cycling. This improves the cycle life of the pouch cell. The GDL fiber mat devoid of lithiophilic material cannot support the Li-metal stability at high current densities/high cathode loadings.

The GDL fiber mat with lithiophilic material coated onto the Li-metal showed stable cycle life even with high loadings of 5.41 mg/cm² and 6.05 mg/cm². The 3D structure served as the host and reduced the local current density thereby facilitating uniform lithium flux whereas the silicon improved the lithium affinity thus creating specific lithiophilic sites. As such, there is a combined beneficial effect of the 3D carbon structure and the lithiophilic material for improving the stability of the lithium metal interface and increasing the cycle life even at high loadings thus achieving areal capacities equivalent to 3-4 mAh/cm².

### Electrochemical Impedance Spectroscopy (EIS)

Lithium protected with GDL showed low impedance in terms of charge transfer resistance until 20 cycles compared to lithium protected with GDL-Si. As the number of cycles progressed there was a gradual increase in the impedance of the lithium protected with GDL. In the EIS after the 80th cycle, the charge transfer resistance of first semi-circle, which was the bulk electrolyte resistance, was nearly the same for both the lithium protected with the GDL and the lithium protected with the GDL-Si, which was approximately 55 ohms. The second semicircle had an electrode resistance that was higher (˜250 ohms) in the case of lithium protected with GDL when compared to the lithium protected with GDL-Si (150 ohm). The higher impedance of Li protected with GDL was due to formation of dendrites and dead lithium. As a result, there was consumption of electrolyte and formation of SEI in every subsequent cycle, which increased the electrode resistance. The lithium protected with GDL-Si had a direct pathway due to the presence of the lithium affinity sites, which maintained the uniformity of the lithium flux, thus minimizing the dendrite and dead lithium formation.

### Postmortem Analysis

To investigate the morphology of the lithium after plating and stripping, the morphology was recorded after 30 cycles. The lithium protected with PVDF-HFP coated GDL showed a bulk agglomerate (30 μm) because of irregular lithium flux during cycling. Although GDL fibers were interconnected, they acted as nucleating sites thus forming dead lithium. The morphology of the lithium protected with GDL-Si was uniform with small sized agglomerates distributed throughout the electrode thus maintaining the uniformity. Even the GDL fibers were uniformly coated with lithium. These observations suggest that the presence of silicon (the lithiophilic material) on the fibers improves the lithium flux, and thus, prevents nucleation and minimizes the formation of dendrites and dead lithium.

### Highlights

1. Developing Li-ion passage channels by pre-lithiation of a carbon fiber mat coated onto the Li-metal surface by roll pressing.

2. Improving the integrity or mechanical strength of the carbon fibers by coating with highly elastic polymer.

3. Immobilization and support of the volume change of the lithiophilic material by the elastic polymer.

4. Impregnation of the lithiophilic material in between the carbon fibers of the mat.

5. Attaining a stable cycle life of the pouch cell with an areal capacity of 2.5 mAh/cm² to 3 mAh/cm² in case of lithium coated with a carbon fiber mat and 3.5 mAh/cm² to 4 mAh/cm² with lithium coated with a carbon fiber mat impregnated with the lithiophilic material.

6. A stable cycle life [200 cycles] of the pouch cell with an areal capacity of 3.5 to 4 mAh/cm² was achieved with a thin lithium metal anode having a thickness of 100 micrometers [commercial standard].

### Conclusion

Roll pressing of the carbon fiber mat onto the lithium surface intimately connects the lithium with the carbon fiber which allows for prelithiation and development of a stable lithium metal interface. This coating improved the cycle life for 200 cycles with an areal capacity of 2-3 mAh/cm². A highly elastic polymer coated onto the carbon fiber mat prevents the pulverization of the carbon fiber during roll pressing. Introduction of lithiophilic material further improves the uniformity of the lithium flux that supports the pouch cell with a high areal capacity of 3-4 mAh/cm² for 200 cycles. TTE tends to form a stable SEI on the hard carbon that improves the coulombic efficiency of the pouch cells.

Other embodiments of the present disclosure will be apparent to those skilled in the art from consideration of the specification and practice of the embodiments disclosed herein. As used throughout the specification and claims, “a” and/or “an” and/or “the” may refer to one or more than one. Unless otherwise indicated, all numbers expressing quantities, proportions, percentages, or other numerical values are to be understood as being modified in all instances by the term “about.” Accordingly, unless indicated to the contrary, the numerical parameters set forth in the specification and claims are approximations that can vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

It is to be understood that each component, compound, substituent or parameter disclosed herein is to be interpreted as being disclosed for use alone or in combination with one or more of each and every other component, compound, substituent or parameter disclosed herein.

It is further understood that each range disclosed herein is to be interpreted as a disclosure of each specific value within the disclosed range that has the same number of significant digits. Thus, for example, a range from 1-4 is to be interpreted as an express disclosure of the values 1, 2, 3 and 4 as well as any range of such values.

It is further understood that each lower limit of each range disclosed herein is to be interpreted as disclosed in combination with each upper limit of each range and each specific value within each range disclosed herein for the same component, compounds, substituent or parameter. Thus, this disclosure to be interpreted as a disclosure of all ranges derived by combining each lower limit of each range with each upper limit of each range or with each specific value within each range, or by combining each upper limit of each range with each specific value within each range. That is, it is also further understood that any range between the endpoint values within the broad range is also discussed herein. Thus, a range from 1 to 4 also means a range from 1 to 3, 1 to 2, 2 to 4, 2 to 3, and so forth.

Furthermore, specific amounts/values of a component, compound, substituent or parameter disclosed in the description or an example is to be interpreted as a disclosure of either a lower or an upper limit of a range and thus can be combined with any other lower or upper limit of a range or specific amount/value for the same component, compound, substituent or parameter disclosed elsewhere in the application to form a range for that component, compound, substituent or parameter.

### REFERENCES

All references cited herein are hereby incorporated by reference in their entirety as if fully set forth herein.
1. F.Nobili, M.Mancini, S.Dsoke. R.Tossici, R.Marassi, Low-temperature behavior of graphite-tin composite anodes for Li-ion batteries, Journal of Power Sources, 195 [20], 2010, 7090-7097.
2. Jun Liu, Zhenan Bao, Yi Cui, Eric J. Dufek, John B. Goodenough, Peter Khalifah, Qiuyan Li, Bor Yann Liaw, Ping Liu, Arumugam Manthiram, Y. Shirley Meng, Venkat R. Subramanian1, Michael F. Toney, Vilayanur V. Viswanathan, M. Stanley Whittingham, Jie Xiao, Wu Xu, Jihui Yang, Xiao-Qing Yang and Ji-Guang Zhang, Pathways for practical high-energy long-cycling lithium metal batteries, Nature Energy, 4, 2019, 180-186.
3. Hailong Qiu, Tianyu Tang, Muhammad Asif, Wei Li, Teng Zhang, Yanglong Hou, Stable lithium metal anode enabled by lithium metal partial alloying, Nano Energy, 65, 2019, 103989.
4. Alexander C Kozen, Chuan-Fu Lin, Oliver Zhao, Sang Bok Lee, Gary W. Rubloff, and Malachi Noked, Stabilization of Lithium Metal Anodes by Hybrid Artificial Solid Electrolyte Interphase, Chem. Mater. 2017, 29, 15, 6298-6307.
5. Fanfan Liu, Rui Xu, Zexun Hu, Shufen Ye, Sifan Zeng, Yu Yao, Siqi Li, Yan Yu, Regulating Lithium Nucleation via CNTs Modifying Carbon Cloth Film for Stable Li Metal Anode, Small 2018, 1803734.
6. Sufu Liu, Xinhui Xia, Shengjue Deng, Liyuan Zhang, Yuqian Li, Jianbo Wu, Xiuli Wang, and Jiangping Tu, Large-scale synthesis of high-quality lithium—graphite hybrid anodes for mass-controllable and cycling-stable lithium metal batteries, 15, 2018, 31-36.
7. Jingjing Ma, Jinlong Yang, Yuwei Zhao, Qianli Ma, Zhe Wang, Wei Qian, Bin Xia, Lun Li, Weihao Zeng, Junxin Chen, Hanwen Xu, Shuaishuai Chen, Daping He, Zhenbo Wang, Shichun Mu, Janus-faced graphene substrate stabilizes lithium metal anode, Chemical Engineering Journal, 433, 2022, 133561
8. Tao Jiang, Ke Chen, Jingjing Wang, Zhongli Hu, Gulian Wang, Xu-Dong Chen, Pengfei Sun, Qiaobao Zhang, Chenglin Yan and Li Zhang, Nitrogen-doped graphdiyne nanowall stabilized dendrite-free lithium metal anodes, J. Mater. Chem. A, 2019,7, 27535-27546.
9. Ying Zhang, Boyang Liu, Emily Hitz, Wei Luo, Yonggang Yao, Yiju Li, Jiaqi Dai, Chaoji Chen, Yanbin Wang, Chunpeng Yang, Hongbian Li & Liangbing Hu, A carbon-based 3D current collector with surface protection for Li metal anode, Nano Research volume 10, pages 1356-1365 (2017).
10. Tao Zhang, Huichao Lu, Jun Yang, Zhixin Xu, Jiulin Wang, Shin-ichi Hirano, Yongsheng Guo, and Chengdu Liang, Stable Lithium Metal Anode Enabled by a Lithiophilic and Electron/Ion-Conductive Framework, ACS Nano 2020, 14, 5, 5618-5627.
11. Chengxu Shen, Rusheng Fu, Yonggao Xi, and Zhaoping Liu, New perspective to understand the effect of electrochemical prelithiation behaviors on silicon monoxide, RSC Adv., 2018. 8, 14473-14478.

1. A method of making a protected lithium metal anode comprising steps of:
a) applying a polymer solution to a three-dimensional substrate to form a coated three dimensional substrate,
b) applying the coated three dimensional substrate to a lithium metal surface to form a coated lithium metal surface, and
c) applying pressure to the coated lithium metal surface to form the protected lithium metal anode.

2. The method of claim 1, wherein the three-dimensional substrate comprises from about 1 wt. % to about 30 wt. % of one or more lithiophilic components dispersed therein, based on the total weight of the protected lithium metal anode.

3. (canceled)

4. The method of claim 2, wherein the one or more lithiophilic components is selected from the group consisting of silica, silicon-containing nanoparticles, zinc oxide, cupric oxide, three-dimensional carbon nanotubes, metal oxides, metals, and graphene.

5. The method of claim 2, wherein the three-dimensional substrate comprising one or more lithiophilic components is prepared by:
immersing the three-dimensional substrate in the one or more lithiophilic components to form a mixture, and
mixing the mixture to form a three-dimensional substrate having the one or more lithiophilic components dispersed therein.

6. The method of claim 1, wherein the polymer solution of step a) is prepared by:
dissolving a polymer in an organic solvent at a weight ratio of polymer to solvent of 1:0.5 to less than 1:9 to form the polymer solution.

7. The method of claim 1, wherein the step of applying pressure causes pre-lithiation of the three dimensional substrate.

8. The method of claim 1, wherein the three dimensional substrate is selected from the group consisting of a solid carbon ball, a hollow carbon ball, a porous carbon, single-layer of carbon nanotubes, multiple layers of carbon nanotubes, carbon fibers, doped carbon fibers, and graphene cages.

9. The method of claim 1, wherein the polymer solution is present in an amount of from about 0.1 wt. % to about 8 wt. %, based on the total weight of the protected lithium metal anode.

10. The method of claim 1, wherein the step b) is carried out using drop casting and the step of applying pressure is carried out by roll pressing at about 0.1 rpm to about 0.5 rpm.

11. (canceled)

12. The method of claim 1, wherein the polymer is a high tensile strength polymer selected from the group consisting of polyvinylidene fluoride, polyvinylidene fluoride-hexafluoropropylene, nylon, polyphenylene sulfide (PPS).

13. The method of claim 1, wherein the polymer solution is prepared using a solvent and the solvent is an organic solvent selected from the group consisting of dimethyl formamide and acetone.

14. The method of claim 1, wherein the three dimensional substrate comprises carbon fibers having an average diameter of from about 250 nm to about 2 μm.

15. A protected lithium metal anode prepared by the method of claim 1.

16. A cell comprising the protected lithium metal anode of claim 15, an electrolyte, and a cathode.

17. The cell of claim 16, wherein the cathode comprises one or more materials selected from the group consisting of sulfur, graphite, sulfurized carbon, LiFePO4 (LFP), LiMn2O4 (LMO), lithium nickel manganese spinel (LNMO), lithium cobalt oxide, V2O5, lithium nickel cobalt manganese oxide (NMC), and electrically conductive polymers.

18. The cell of claim 16, wherein the cathode is prepared by:
a) mixing a conductive polymer, a nitrogen-containing polymer, or a combination of a conductive polymer and a nitrogen-containing polymer with sulfur in the presence of a solvent to form a mixture, wherein a weight ratio of the conductive polymer and/or nitrogen containing polymer to the sulfur is from about 1:2 to about 1:8; and
b) heating the mixture to a temperature of from about 250° C. to about 400° C. under a pressure of from about 0.05 bar to about 2.0 bar to form the cathode.

19. The cell of claim 16, wherein the electrolyte is a carbonate electrolyte selected from the group consisting of ethylene carbonate, dimethylcarbonate, methylethyl carbonate, fluoro-ethylene carbonate, diethylcarbonate, propylene carbonate, vinylene carbonate, allyl ethyl carbonate, and mixtures thereof.

20. The cell of claim 16, wherein the electrolyte comprises 2 vol. % to about 5 vol. % of a 1,1,2,2-tetrafluoroethyl-2,2,3,3-tetrafluoropropyl ether stabilizing agent, based on the total volume of the electrolyte.

21. (canceled)

22. A battery comprising one or more of the cells according to claim 16.

23. The battery of claim 22, having an energy density of about 350 W-h/kg to about 700 W-h/kg, based on the weight of the battery.

24. A protected lithium metal anode comprising:
lithium metal;
an elastic high tensile polymer layer, and
a pre-lithiated three dimensional substrate impregnated with one or more lithiophilic components.

25. The protected lithium metal anode of claim 24, wherein the polymer of the polymer layer is selected from the group consisting of polyvinylidene fluoride, polyvinylidene fluoride hexafluoropropylene, nylon, polyphenylene sulfide (PPS).

26. The protected lithium metal anode of claim 24, wherein the one or more lithiophilic components is selected from the group consisting of silica, silicon-containing nanoparticles, zinc oxide, cupric oxide, three-dimensional carbon nanotubes, and graphene.
